(19) United States
(12) Patent Application Publication
(10) Pub. No.: US 2017/0311269 A1
(43) Pub. Date: Oct. 26, 2017

(54) WIRELESS ACCESS POINT MANAGING APPARATUS

(71) Applicant: ARRIS Enterprises LLC, Suwanee, GA (US)

(72) Inventors: Charles Hardt, Lawrenceville, GA (US); Dmitry Barablin, Lawrenceville, GA (US)

(21) Appl. No.: 15/134,533

(22) Filed: Apr. 21, 2016

(51) Int. Cl. H04W 52/26; H04W 52/02; H04W 4/00; H04W 84/12; H04W 88/12

(52) U.S. Cl. CPC H04W 52/265; H04W 52/0206; H04W 4/008; H04W 88/12; H04W 84/12

(57) ABSTRACT

A wireless access point managing apparatus for achieving power savings by turning off access points that are not providing the high signal quality. The wireless access point determines whether a first signal quality level is at or above a threshold level, and if so, sends a power-up signal to a second access point, and determines whether the first signal quality level is higher or lower than a second quality level, i.e., the level from the second access point, transfers a streaming session to the second access point if the first signal quality level is lower than second signal quality level. If the first signal quality level is higher than the second signal quality level, the apparatus sends a power-down signal to the second access point.

### BACKGROUND

Power consumption in the home is always a concern. In order to conserve power, electronic devices that are not in use need to be automatically shutdown or switched off. There is currently no managed method, which would automatically shut down a Wi-Fi radio of an Access Point (AP) or that of a software enabled access point (SoftAP/Extender) if not in use. A SoftAP is a software method of enabling a set-top-box or other device to be used as a wireless access point.

For those homes that have more than one Wi-Fi AP, any given Wi-Fi station, e.g., electronic device with wireless communication functions, will probably have better signal quality to only one of the APs in the home. Depending on the number of wireless electronic devices within the home and their relative signal quality to any given AP, it may be advantageous from a power consumption standpoint to shut off at least one of the APs.

### SUMMARY

The present disclosure is directed to an apparatus having the ability to detect the relative signal quality between an access point (AP) and a wireless electronic device (or multiple APs and an electronic device), then determining which AP provides the best signal quality to the electronic device. Then steering a device(s) over to the AP with the better signal quality, and finally shutting off the Wi-Fi radio(s) on the AP(s) with the lessor signal quality (if possible).

In order to manage multiple access points based on the signal qualities thereof, the present application discloses a wireless access point managing apparatus that includes a radio and wireless communication control circuitry that communicates information via the radio between the wireless access point managing apparatus and at least one electronic device so as to provide a first wireless access point to a network, e.g., a wireless LAN, for the electronic device. The wireless access point managing apparatus also includes first communication control circuitry that communicates information between the wireless access point managing apparatus and a separate access point apparatus that provides a second wireless access point to the network. The first communication control circuitry could be a wired connection and circuitry implementing communication according to Ethernet or MoCA protocol.

The wireless access point managing apparatus also includes a hardware processor and a memory having stored therein a program that causes the hardware processor to perform access point management including: receiving, via the wireless communication control circuitry, a first quality signal from the electronic device, the first quality signal indicating a signal quality between the electronic device and the first wireless access point; determining whether the first quality signal indicates a signal quality level that is at or above a threshold level; and sending a power-up signal, via the first communication control circuitry, to the separate access point apparatus to power-up a radio of the separate access point apparatus if it is determined that the first quality signal indicates that the signal quality level is not at or above the threshold level.

The program in the memory can further cause the hardware processor to: receive, via the wireless communication control circuitry, a second quality signal from the electronic device, the second quality signal indicating a signal quality between the electronic device and the second wireless access point provided by the separate access point apparatus; determine whether the first quality signal indicates a signal quality level that is higher or lower than the signal quality level indicated by the second quality signal; transfer a streaming session with the electronic device to the second access point apparatus if it is determined that the first quality signal indicates a signal quality level that is lower than the signal quality level indicated by the second quality signal; and send a power-down signal, via the first communication control circuitry, to the second access point apparatus to power-down the radio of the second access point apparatus if it is determined that the first quality signal indicates a signal quality level that is higher than the signal quality level indicated by the second quality signal.

The program in the memory can further cause the hardware processor to power-down the radio of the wireless access point managing apparatus if it is determined that the first quality signal indicates a signal quality level that is lower than the signal quality level indicated by the second quality signal.

As discussed above, the first communication control circuitry can implement wired communication, but it can also or alternatively include a further radio and further wireless communication control circuitry, and wirelessly communicate information between the wireless access point managing apparatus and the separate access point apparatus. Such further wireless communication control circuitry can be configured to communicate according to a Bluetooth protocol, whereas the wireless communication control circuitry for communication with the wireless electronic devices can be configured to communicate according to a Wi-Fi protocol.

### BRIEF DESCRIPTION OF THE DRAWINGS

FIG. 1 is an example of a network system in a home or other building having multiple access points serving multiple stations.

FIG. 2 is a block diagram of an embodiment of the wireless access managing apparatus.

FIG. 3 is a block diagram of an embodiment of the communication circuit.

FIG. 4 is a timing diagram of communications among access points and wireless electronic devices.

### DETAILED DESCRIPTION

Exemplary embodiments will be described in detail below with reference to the drawings. The description and drawings are provided so that a person skilled in the art can fully understand the present disclosure and are not intended to limit the subject matter recited in the claims.

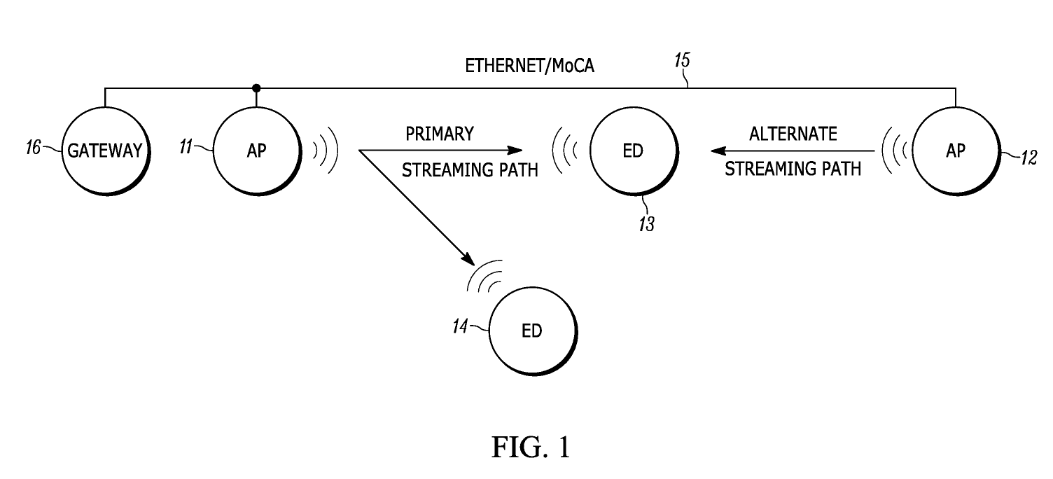

As shown for example in FIG. 1, many homes or other facilities today have wireless networks including more than one access point (AP) 11, 12. Access point 12, and/or any additional APs not shown in FIG. 1, could be a software enabled access point or Wi-Fi extender (SoftAP/extender). Such wireless networks also potentially have multiple wireless electronic devices 13, 14, . . . , etc. Wi-Fi radios in the APs can consume anywhere from 2 to 3 Watts of power, even if the radio is in a receive-only mode. It is advantageous from a power conservation perspective to shut off any Wi-Fi radio that is not in use, or that is potentially under utilized.

The multiple APs are linked together via a wired connection 15 such as Ethernet or MoCA. This connection can alternatively be a wireless connection such as Wi-Fi or Bluetooth. The multiple APs 11 and 12 can exchange data or video streams using the wired connection 15, as a back haul mechanism. A gateway device 16 could then potentially use any AP in the home, e.g., AP 11 or AP 12, to provide a Wi-Fi connection to an electronic device 13, 14.

Within any home with multiple APs, one of the APs will more than likely have a better signal quality to a particular wireless electronic device. A better signal quality will also have the positive side effect of being able to maintain a higher data link to the targeted device.

It would be advantageous in regards to data throughput to steer the electronic device from the AP with the weaker signal quality over to the AP with the better quality signal. It is not the objective of this disclosure to deal with the concept of steering electronic devices to various APs, rather the disclosure objective has to do with lowering Wi-Fi power consumption levels in a home with multiple APs.

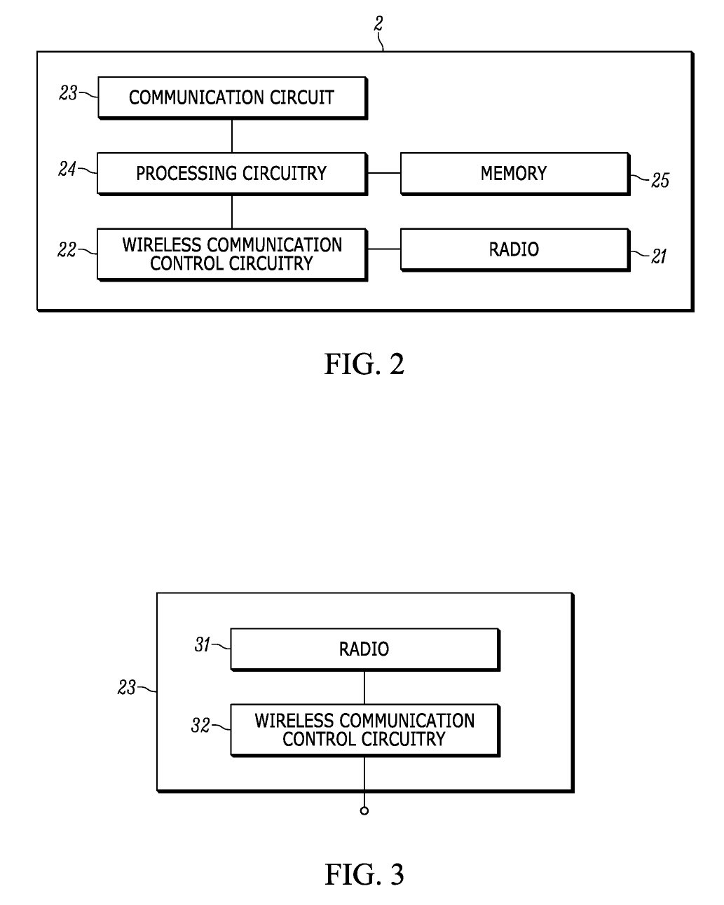

An embodiment of the wireless access managing apparatus 2 of the present invention is shown in FIG. 2. The wireless access management apparatus can include functions of the Gateway 16 and/or the primary AP 11 shown in FIG. 1, and determines which AP each particular wireless electronic device should be attached to. The wireless access apparatus 2 periodically, for example, every ten minutes, determines if the signal quality between an AP and its associated electronic device is better than the potential signal quality to a secondary AP.

As illustrated in FIG. 2, the wireless access point managing apparatus 2 includes a radio 21 and wireless communication control circuitry 22 that communicates information via the radio 21 between the wireless access point managing apparatus 2 and at least one electronic device so as to provide a first wireless access point to a network for the electronic device. The electronic devices 13 and 14 can be any device or Wi-Fi station that can communicate via Wi-Fi, such as a music player, a mobile phone, a tablet device, a notebook device, a laptop computer, a desktop computer, or a gaming system.

The wireless access management apparatus 2 includes a communication circuit 23, (also referred to as first communication control circuitry), that communicates information between the wireless access point managing apparatus 2 and a separate access point apparatus that provides a second wireless access point to the network, such as access point apparatus 12 shown in FIG. 1.

The wireless access management apparatus 2 also includes processing circuitry 24, such as a hardware processor. Alternatively, the processing circuitry can be one or more integrated circuits. Specific examples of technologies for implementing the processing circuitry 24 are discussed below. A memory 25, such as a ROM or RAM, has stored therein a program that causes the processing circuitry to perform access point management.

The access point management performed by the processing circuitry 24 includes receiving, via the wireless communication control circuitry 22 and radio 21, a first quality signal from the electronic device. The first quality signal indicates a signal quality between the electronic device and the first wireless access point 11. The processing circuitry then determines whether the first quality signal indicates a signal quality level that is at or above a threshold level, and sends a power-up signal, via the communication circuit 23, to the separate access point apparatus 12 to power-up a radio of the separate access point apparatus 12 if it is determined that the first quality signal indicates that the signal quality level is not at or above the threshold level.

In this way, if it is determined that the first access point 11, provided by the wireless access point managing apparatus 2, is not delivering adequate signal quality to the wireless electronic device, the wireless access point managing apparatus powers up the second access point 12. For example, as shown in FIG. 1, if the electronic device is the electronic device (ED) 14, which is near the access point 11 provided by the wireless access point managing apparatus 2, then the first quality signal indicates that the signal quality is at the threshold level, in which case the processing circuitry 24 would determine that the signal meets the threshold requirement, and therefore would not power up the second access point 12. However, if for example the electronic device is the electronic device (ED) 13 shown in FIG. 1, which is further away from the access point 11 provided by the access point managing apparatus, then consider that in this example the first quality signal indicates that the signal quality is not at or above the threshold level, in which case the processing circuitry 24 would determine that the signal does not meet the threshold requirement, and therefore would send an instruction to power up the second access point 12. This threshold signal quality determination is then repeated for any other wireless electronic device on the network.

Once the second access point 12 is powered up, the processing circuitry 24 receives, via the wireless communication control circuitry 22 and radio 21, a second quality signal from the electronic device 13. This second quality signal indicates a signal quality between the electronic device 13 and the second wireless access point 12. The processing circuitry 24 then determines whether the first quality signal indicates a signal quality level that is higher or lower than the signal quality level indicated by the second quality signal. If it is determined that the first quality signal indicates a signal quality level that is lower than the signal quality level indicated by the second quality signal, the processing circuitry 24 transfers the streaming session with the electronic device 13 to the second access point apparatus 12. On the other hand, if it is determined that the first quality signal indicates a signal quality level that is higher than the signal quality level indicated by the second quality signal, the processing circuitry 24 sends a power-down signal, via the communication circuit 23, to the second access point apparatus 12 to power-down the radio of the second access point apparatus 12.

In this way, if it is determined that the first access point 11, provided by the wireless access point managing apparatus 2, provides a signal quality to the wireless electronic device that is better than the signal quality provided by second access point 12, the processing circuitry 24 powers down the access point 12 that is providing the lower quality signal as detected by the electronic device 13, and thus retains the wireless communication between the wireless access point 11 provided by the access point managing apparatus 2 and the electronic device 13.

Thus, the first quality signal may indicate that the signal quality is higher at the device 13 from the access point 11 than the signal quality at the device 13 from the second access point 12, in which case the processing circuitry 24 would determine this to be the case, and therefore would proceed to power down the second access point 12. However, if on the other hand the first quality signal indicates that the signal quality is lower at the device 13 from the access point 11 than the signal quality at the device 13 from the second access point 12, the processing circuitry 24 would determine this to be the case, and therefore would not power down the second access point 12, but instead transfers the streaming session with the electronic device to the second access point apparatus 12. The above described process of determining which AP provides the highest signal quality is repeated for each wireless electronic device on the network. For any given electronic device, an AP could be determined to not be providing the highest quality signal level among the available APs on the network. However, such an AP could be providing the highest quality signal level to another electronic device. In such a case, the AP would not be powered-down. Therefore, if the access point managing is performed for each wireless electronic device on the network, each electronic device will be matched to the AP that provides it with the highest quality signal level, and any APs that do not provide the highest quality signal level to any wireless electronic device will be shut down. Powering down APs will reduce the overall power consumption.

As a further power savings measure, if it is determined that the first quality signal indicates a signal quality level that is lower than the signal quality level indicated by the second quality signal, i.e., if the second access point 12 provides a better quality signal to the electronic device 13, the processing circuitry 24 can be configured to power-down the radio 21 of the wireless access point managing apparatus 2.

The communication circuit can be a wired connection for effecting communication according to an Ethernet or MoCA protocol over the connection 15. Alternatively, as shown in FIG. 3, the communication circuit can include a further radio 31, and further wireless communication control circuitry 32, and wirelessly communicate information between the wireless access point managing apparatus 2 and the separate access point apparatus 12. The further wireless communication control circuitry 32 can be configured to communicate according to a Bluetooth protocol, whereas the wireless communication control circuitry 22 is configured to communicate according to a Wi-Fi protocol.

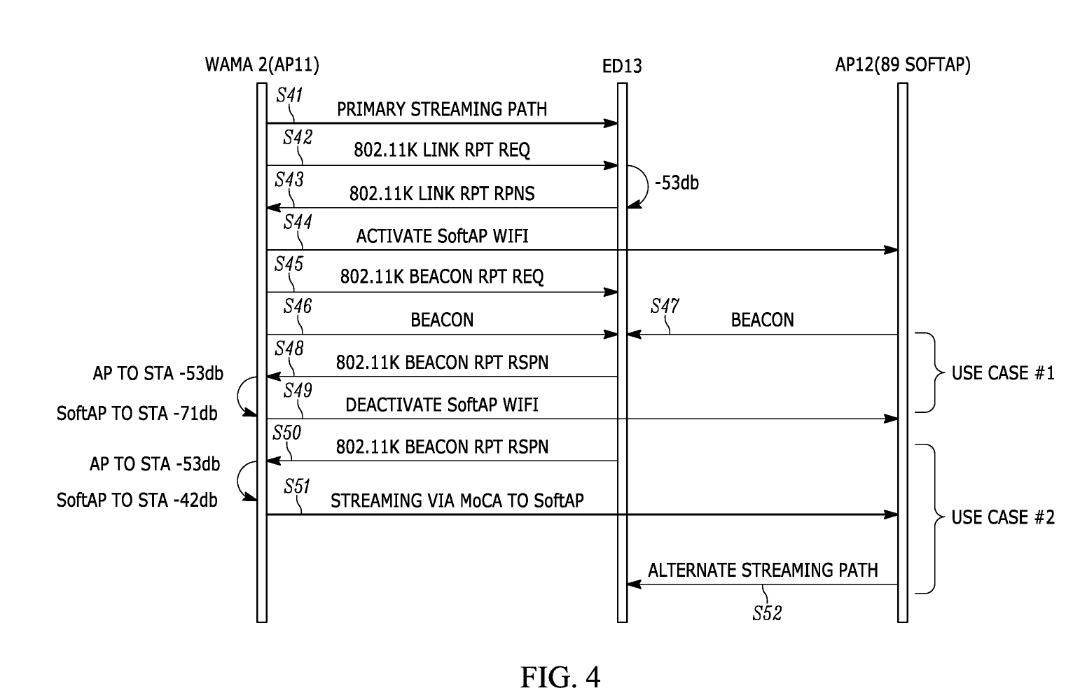

FIG. 4, is a transition diagram of events related to selecting and activating/deactivating the radio on the second access point 12, and including the process of switching between access point 11 provided by the wireless access point managing apparatus 2 and the second access point 12.

In the example shown in FIG. 4, the wireless access managing apparatus 2 (abbreviated WAMA in FIG. 4) includes the access point 11 which is initially acting as the Wi-Fi AP for the electronic device 13, i.e., the primary streaming path S41. The Wi-Fi radio of the second access point 12 is initially off, i.e., in a low power mode. At S42, the access point managing apparatus 2, via the wireless communication control circuitry 22 and radio 21, requests an 802.11k based “Link Report” from the electronic device 13. This report includes the signal quality of the first access point 11, as detected by the electronic device 13. The report is sent by the electronic device 13 to the wireless access point managing apparatus 2 at S43. In this example, the signal quality level is −53 dB.

If the signal quality between the first access point 11 and the electronic device 13 is not at or above a predetermined threshold, e.g., an “excellent” level, then at S44 the wireless access managing apparatus 2 sends a message, i.e., a power-up signal, to the second access point 12 to switch on its Wi-Fi radio. In this example, consider that the second access point 12 can be a SoftAP. The message is sent via the wired connection 15 according to Ethernet or MoCA protocol. However, as discussed above, this message can be sent wirelessly, such as by Bluetooth protocol.

Once the radio of the second access point 12 is up and running, the access point managing apparatus 2 sends an 802.11k Beacon report request to the electronic device 13 at S45. Then, at S46 and S47, the electronic device 13 collects information concerning any/all APs that the electronic device 13 detects, which in this example are access points 11 and 12. This information is then sent back to the wireless access managing apparatus 2 at S48/S50 (Use Case #1 in FIG. 4).

The wireless access point managing apparatus 2 then analyzes the returned data to determine which access point the electronic device 13 has a better quality signal with. If for example, the signal quality at the electronic device 13 from the first access point 11 is −53 dB, which is better than the signal quality at the electronic device 13 from the second access point 12 which is −71 dB, then the wireless access managing apparatus 2 sends a message to the second access point 12 to deactivate the radio of the second access point 12 at S49, putting it in low power mode. However, if the electronic device 13 has a better quality signal from the second access point 12, i.e., −42 dB, than the signal quality at the electronic device 13 from the first access point 11, i.e., −53 dB, then the wireless access point managing apparatus 2 does not instruct the second access point 12 to deactivate the radio of the second access point 12, and the radio of the second access point 12 is left in the powered on state. This is represented by Use Case #2 in FIG. 4, where the wireless access managing apparatus 2 at S51 transfers the streaming session to the second access point 12 so that the steaming to the electronic device 13 is conducted by the second access point 12 rather than the first access point 11, S52.

If no station is attached to the first access point 11, then the radio in the first access point 11 could be placed in a low power mode.

The process described in FIG. 4, would be repeated periodically, for example, every 1 minute, 5 minutes, 10 minutes, etc.

The present invention can be implemented not only as an apparatus or apparatuses, but also as a method including the steps as discussed above and illustrated in FIG. 4, which methods as discussed above constitute examples of algorithms. The invention can also be implemented as a program on a non-transitory computer-readable medium for causing a computer to execute such steps. The non-transitory computer-readable recording medium could be, for example, a CD-ROM, DVD, Bluray disc, or an electronic memory device.

The present invention may be implemented as any combination of a system, a method, an integrated circuit, and a computer program on a non-transitory computer readable recording medium.

The wireless access point managing apparatus 2 may be in the form of a set-top box or other standalone device, or may be incorporated in a television or other content playing apparatus, or other device and the scope of the present invention is not intended to be limited to such forms.

The blocks illustrated in FIGS. 2 and 3 may be formed in individual chips, or any or all of these blocks may be included and formed in one chip. The technology of implementation of the circuitry can be Large Scale Integration (LSI), but may also be referred to as an IC, a system LSI, a super LSI, or an ultra LSI in accordance with the different degrees of integration. These technologies allow for the circuitry of the present invention to be integrated as a computer system configured by including a microprocessor, a ROM, a RAM, and the like, wherein a computer program is stored in the ROM and the microprocessor implements the stored program to achieve the function of the program.

A method for implementing the integrated circuit is not limited to LSI. The integrated circuit may also be implemented by a dedicated circuit or a versatile processor.

If a new technique for integrated circuit production arises, such new technique may be used to implement the blocks shown in FIG. 2.

Components of the wireless access point managing apparatus may also be implemented as a specifically programmed general purpose processor, CPU, a specialized microprocessor such as Digital Signal Processor that can be directed by program instructions, a Field Programmable Gate Array (FPGA) that can be programmed after manufacturing, or a reconfigurable processor. Some or all of the functions may be implemented by such a processor while some or all of the functions may be implemented by circuitry in any of the forms discussed above.

The present invention may be a non-transitory computer-readable recording medium having recorded thereon a program embodying the methods/algorithms discussed above for instructing a processor to perform the methods/algorithms.

Each of the elements of the present invention may be configured by implementing dedicated hardware or a software program controlling a processor to perform the functions of any of the components or combinations thereof. Any of the components may be implemented as a CPU or other processor reading and executing a software program from a recording medium such as a hard disk or a semiconductor memory.

The sequence of the steps included in the above described algorithms and that illustrated in FIG. 4 are illustrative, and algorithms having a sequence other than the above described sequences are contemplated. Moreover, steps, or parts of the algorithm, may be implemented simultaneously or in parallel where appropriate.

It is also contemplated that the implementation of the components of the present invention can be done with any newly arising technology that may replace any of the above implementation technologies.

We claim:

1. A wireless access point managing apparatus comprising:
a radio;
wireless communication control circuitry that communicates information via the radio between the wireless access point managing apparatus and at least one electronic device so as to provide a first wireless access point to a network for the electronic device;
first communication control circuitry that communicates information between the wireless access point managing apparatus and a separate access point apparatus that provides a second wireless access point to the network;
a hardware processor; and
a memory having stored therein a program that causes the hardware processor to perform access point management including:
receiving, via the wireless communication control circuitry, a first quality signal from the electronic device, the first quality signal indicating a signal quality between the electronic device and the first wireless access point;
determining whether the first quality signal indicates a signal quality level that is at or above a threshold level;
sending a power-up signal, via the first communication control circuitry, to the separate access point apparatus to power-up a radio of the separate access point apparatus if it is determined that the first quality signal indicates that the signal quality level is not at or above the threshold level.

2. The wireless access point managing apparatus according to claim 1, wherein the program in the memory further causes the hardware processor to:
receive, via the wireless communication control circuitry, a second quality signal from the electronic device, the second quality signal indicating a signal quality between the electronic device and the second wireless access point provided by the separate access point apparatus;
determine whether the first quality signal indicates a signal quality level that is higher or lower than the signal quality level indicated by the second quality signal;
transfer a streaming session with the electronic device to the second access point apparatus if it is determined that the first quality signal indicates a signal quality level that is lower than the signal quality level indicated by the second quality signal; and
send a power-down signal, via the first communication control circuitry, to the second access point apparatus to power-down the radio of the second access point apparatus if it is determined that the first quality signal indicates a signal quality level that is higher than the signal quality level indicated by the second quality signal.

3. The wireless access point managing apparatus according to claim 2, wherein the program in the memory further causes the hardware processor to power-down the radio of the wireless access point managing apparatus if it is determined that the first quality signal indicates a signal quality level that is lower than the signal quality level indicated by the second quality signal.

4. The wireless access point managing apparatus according to claim 1, wherein:
the first communication control circuitry comprises a wired connection.

5. The wireless access point managing apparatus according to claim 1, wherein:
the first communication control circuitry comprises Ethernet or MoCA communication circuitry.

6. The wireless access point managing apparatus according to claim 1, wherein:
the first communication control circuitry comprises a further radio, and further wireless communication control circuitry, and wirelessly communicates information between the wireless access point managing apparatus and the separate access point apparatus.

7. The wireless access point managing apparatus according to claim 6, wherein:
the further wireless communication control circuitry is configured to communicate according to a Bluetooth protocol.

8. The wireless access point managing apparatus according to claim 1, wherein:
the wireless communication control circuitry is configured to communicate according to a Wi-Fi protocol.

9. A wireless access point managing method comprising:
communicating information via wireless communication control circuitry and a radio with at least one electronic device so as to provide a first wireless access point to a network for the electronic device;
communicating information via first communication control circuitry with a separate access point apparatus that provides a second wireless access point to the network;
receiving, via the wireless communication control circuitry, a first quality signal from the electronic device, the first quality signal indicating a signal quality between the electronic device and the first wireless access point;
determining whether the first quality signal indicates a signal quality level that is at or above a threshold level; and
sending a power-up signal, via the first communication control circuitry, to the separate access point apparatus to power-up a radio of the separate access point apparatus if it is determined that the first quality signal indicates that the signal quality level is not at or above the threshold level.

10. The wireless access point managing method according to claim 9, further comprising:
receiving, via the wireless communication control circuitry, a second quality signal from the electronic device, the second quality signal indicating a signal quality between the electronic device and the second wireless access point provided by the separate access point apparatus;
determining whether the first quality signal indicates a signal quality level that is higher or lower than the signal quality level indicated by the second quality signal;
transfering a streaming session with the electronic device to the second access point apparatus if it is determined that the first quality signal indicates a signal quality level that is lower than the signal quality level indicated by the second quality signal; and
sending a power-down signal, via the first communication control circuitry, to the second access point apparatus to power-down the radio of the second access point apparatus if it is determined that the first quality signal indicates a signal quality level that is higher than the signal quality level indicated by the second quality signal.

11. The wireless access point managing method according to claim 10, further comprising:
powering-down the first wireless access point if it is determined that the first quality signal indicates a signal quality level that is lower than the signal quality level indicated by the second quality signal.

12. The wireless access point managing apparatus according to claim 9, wherein:
the communicating via the first communication control circuitry is via a wired connection.

13. The wireless access point managing apparatus according to claim 9, wherein:
communication via the first communication control circuitry is with an Ethernet or MoCA protocol.

14. The wireless access point managing apparatus according to claim 9, wherein:
the communication via the first communication control circuitry is wireless communication.

15. The wireless access point managing apparatus according to claim 14, wherein:
the wireless communication is performed according to a Bluetooth protocol.

16. The wireless access point managing apparatus according to claim 9, wherein:
the communication via the wireless communication control circuitry is performed according to a Wi-Fi protocol.
